(19) United States
(12) Patent Application Publication
(10) Pub. No.: US 2008/0232488 A1
(43) Pub. Date: Sep. 25, 2008

(54) WIRELESS COMMUNICATIONS APPARATUS AND METHOD

(75) Inventors: Magnus Stig Torsten SANDELL, Bristol (GB); Andrew George LILLIE, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/955,952

(22) Filed: Dec. 13, 2007

(30) Foreign Application Priority Data
Feb. 8, 2007 (GB) 0702495.3

(51) Int. Cl. H04L 27/28

(52) U.S. Cl. 375/260

(57) ABSTRACT

Detection of information on an OFDM signal involves channel estimation. Following an initial channel estimate, it is desirable to perform smoothing or filtering to achieve a more effective channel estimate. A filter is described which is operable to smooth an initial estimate for a subcarrier by reference to one or more adjacent subcarrier estimates. Extrapolation is used to impose, on a subcarrier, information dependent on one or more other subcarriers in the case that the subcarrier in question is not in use other than use by the filter.

The present invention concerns channel estimation in OFDM wireless communications apparatus.

Channel estimation is an important task in OFDM receivers since poor knowledge of the channel can lead to significant errors in decoding data. It is known to construct networks from apparatus pre-configured to send, and to recognise in received transmissions, a dedicated part of a transmitted signal consisting of a training sequence. Although this training sequence allows channel estimation, the quality of resultant estimates can be poor. Using the fact that the length of the channel impulse response is generally much smaller than the length of the OFDM symbol, techniques have been proposed to improve the quality of the channel estimation.

One common approach is to estimate the channel in the time domain by transforming the initial channel estimate (van de Beek, J.-J.; Edfors, O.; Sandell, M.; Wilson, S. K.; Boijesson, P. O.; “On channel estimation in OFDM systems”, Vehicular Technology Conference, 1995, pages 815-819 vol. 2). A window may then be applied which removes noise without affecting the channel itself. Although this can give very good performance in theory, it introduces a significant practical problem in that it involves a number of Fast Fourier Transform (FFT) operations which, as will be appreciated by the skilled reader, increases computational complexity significantly. This problem is particularly pronounced in MIMO systems, where the channel from each transmit-receive antenna pair must be treated in this way. With increasing numbers of transmit-receive antenna pairs, the complexity problem can become most significant.

Another technique is to apply a filter in the frequency domain to make use of the frequency correlation of the channel. This approach has lower complexity than the time-domain algorithms. One problem with this approach is that subcarriers near the edge of the band must be treated differently since they have only information on one side of the them, not on both as is the case of a subcarrier in the middle of the band. This is discussed further in “Pilot aided channel estimation for OFDM: a separated approach for smoothing and interpolation” (Auer, G.; Karipidis, E.; ICC2005, pages 2173-2178 Vol. 4).

In general terms, an aspect of the invention provides a channel estimator and a method of estimating a channel, primarily for use in an OFDM communications system, wherein subcarriers at the edge of the band can be treated differently by first extrapolating the existing subcarriers to populate a non-existing (virtual) subcarrier. A simple FIR filter may then be applied without treating the edge of the band subcarrier differently, thus allowing for a very simple filter implementation. The extrapolation may be done by simply copying values, hence avoiding any extra complexity overhead.

According to an aspect of the invention, there is provided communications apparatus for receiving a signal comprising a plurality of signal elements, the elements being modulated across a plurality of subcarriers defined by way of transmission frequency, the apparatus comprising channel estimation means operable to determine a channel estimate comprising a plurality of respective subcarrier estimates, the channel estimation means comprising a filter operable to smooth an initial estimate for a subcarrier by reference to one or more adjacent subcarrier estimates, wherein the channel estimation means further comprises extrapolation means operable to impose on a subcarrier information dependent on one or more other subcarriers in the case that the subcarrier in question is not in use other than use by said filter.

The filter may be operable to smooth an initial estimate for a subcarrier by reference to one or more subcarrier estimates to one side of the subcarrier and to the same number of subcarrier estimates on the other side of the subcarrier.

The filter may be operable to smooth an initial estimate for a target subcarrier by reference to the initial estimate and initial subcarrier estimates for four further subcarriers, two being directly adjacent said subcarrier and two being directly adjacent said directly adjacent subcarriers distal said target subcarrier.

It will be appreciated that the initial estimates may be of any form, and need not be the very first estimates made for a subcarrier; they are to be intended as the initial estimates for the filtering according to the invention.

The filter may be a linear filter. Preferably, the filter is a linear filter defined by a plurality of fixed filter coefficients.

The extrapolation means may be operable to determine information to be imposed on a subcarrier as a copy of information of another subcarrier. As an alternative, the extrapolation means may be operable to extrapolate from one or more other subcarriers information to be imposed on a subcarrier.

The extrapolation means may be operable on a subcarrier otherwise not in use, to impose information on said subcarrier to enable use of the subcarrier as one of the adjacent subcarriers for use by the filter.

According to another aspect of the invention, there is provided a method of determining a channel estimate for a channel comprising a plurality of subcarriers by frequency, comprising the steps of determining an initial estimate for each subcarrier utilised in said channel, identifying further subcarriers adjacent said utilised subcarriers to enable use of a fixed window filter on each said utilised subcarrier, extrapolating initial subcarrier information to a further subcarrier from one or more utilised subcarriers, and filtering subcarrier information for a plurality of subcarriers using said fixed window filter to determine a smoothed estimate for each utilised subcarrier.

It will be appreciated that aspects of the invention can also be implemented by means of hardware configured by suitable software, which can be provided to the hardware by any suitable medium. Such a medium could be an optical or magnetic storage device (such as a disk), a non-volatile memory device, such as a Flash memory, or a computer receivable signal carrying a file of instructions whether directly executable or encoded to allow a user to cause installation of a suitable executable program. For instance, a codec could be provided to a device by a received Short Message Service (SMS) message.

Specialised hardware devices could alternatively be provided for integration into a general purpose computer. By this, an ASIC or an FPGA could be provided with sufficient functionality such that the thereby configured computer results in a device in accordance with an aspect of the invention or operable to perform a method in accordance with an aspect of the invention.

Specific embodiments of the invention will now be described, by way of example only, with reference to the accompanying drawings, in which:

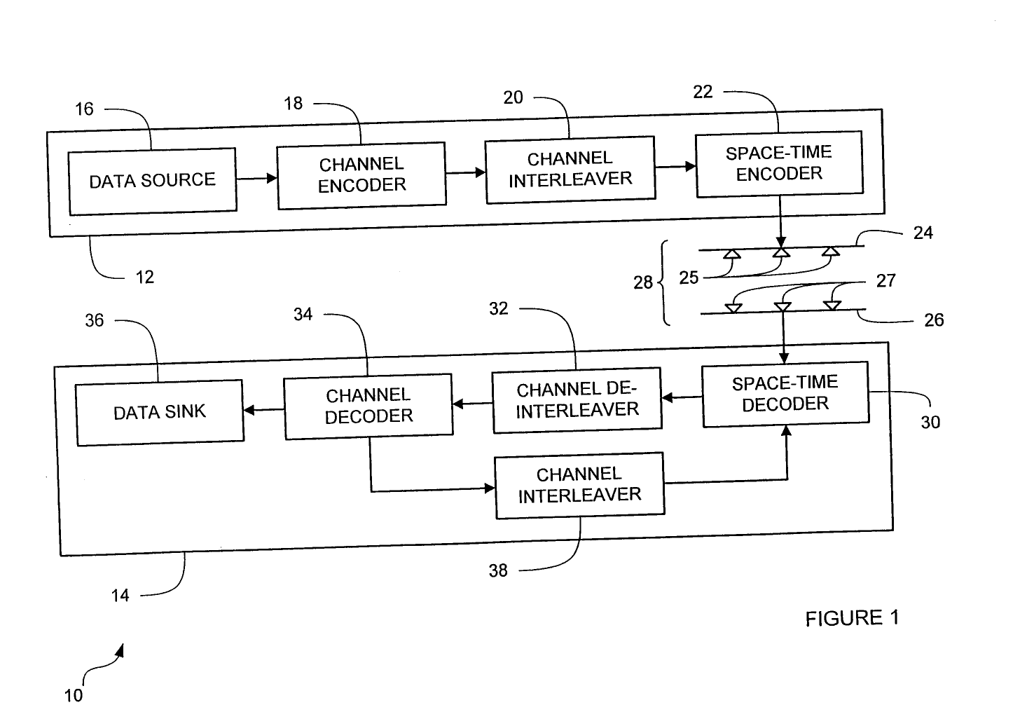

FIG. 1 is a schematic diagram of an OFDM network on which an embodiment of the invention will be demonstrated;

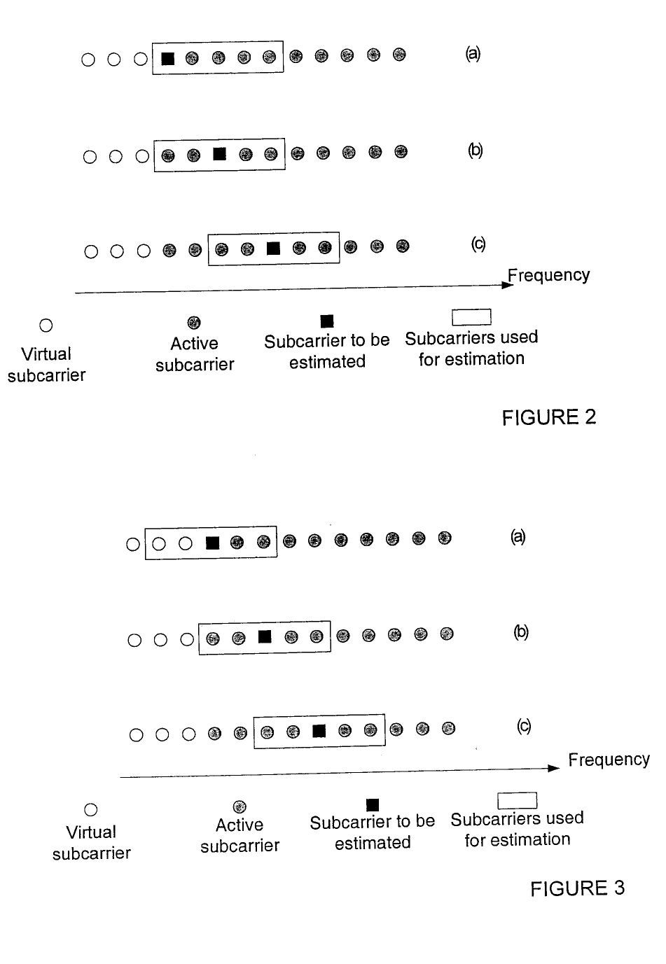

FIG. 2 is a schematic diagram of an example of smoothing using nearest active subcarriers;

FIG. 3 is a schematic diagram of an example of smoothing using nearest active and virtual subcarriers in accordance with the specific embodiment of the invention;

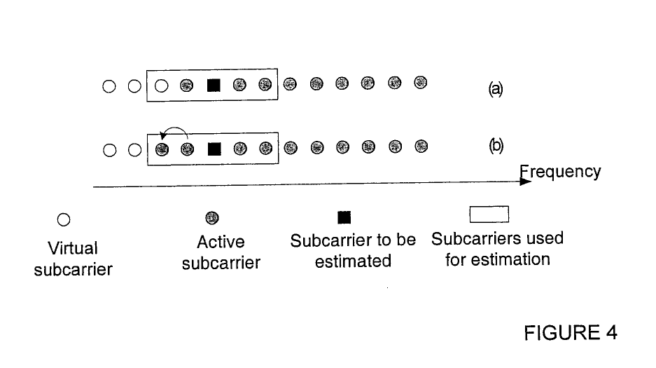

FIG. 4 is a schematic diagram of an example of extrapolating information to virtual subcarriers, in accordance with the specific embodiment of the invention;

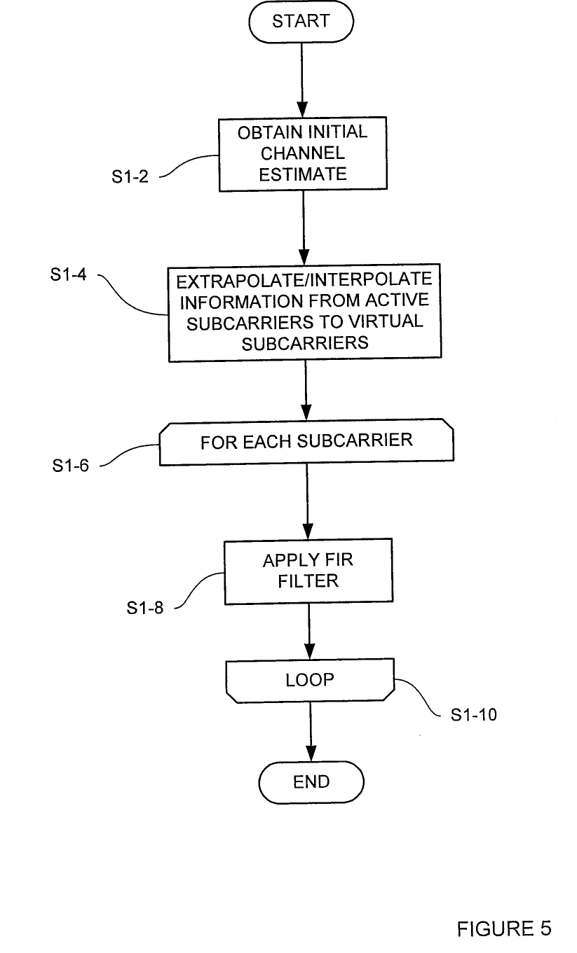

FIG. 5 is a flow diagram setting out steps of a method of determining smoothed estimates for all subcarriers in a MIMO channel, in accordance with the specific embodiment; and

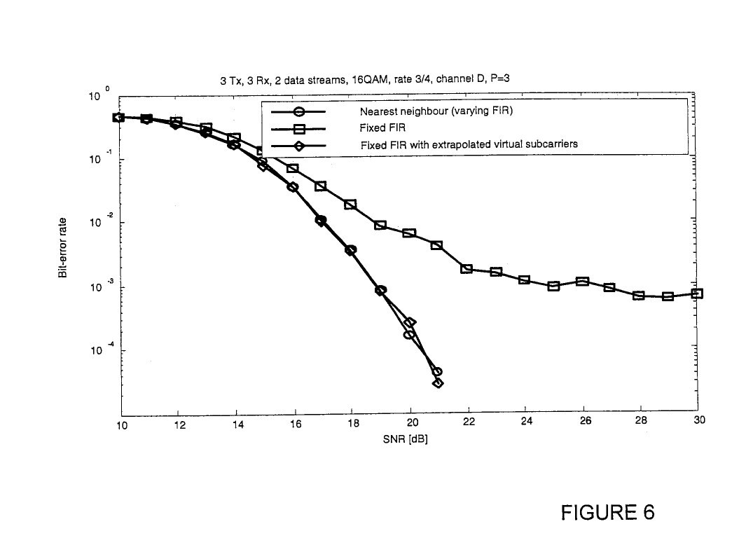

FIG. 6 is a graph showing experimental data for a computer implemented model of the specific embodiment.

In this description of a specific embodiment of the invention, “nulled” or “non-existing” subcarriers are collectively described as “virtual” subcarriers. These may be subcarriers on which nothing is transmitted, for instance to fit a spectral mask, or may be out-of-band subcarriers, that is they are not available in the receiver, for instance because the receiver is incapable of detecting subcarriers in the frequencies concerned. Both types of subcarrier have the property of not containing any information about other subcarriers and are hence undesirable to use in the filtering process.

These can be avoided by always choosing the nearest active subcarriers, but this has the disadvantage of changing the (relative) filter window. This results in having to change the filter coefficients, which complicates the filtering. If the filter coefficients are fixed, a simple and well-understood FIR filter can be used without the need for changing filter coefficients. The advantage of this is reduced memory requirement and access.

A typical OFDM network 10 is exemplified in FIG. 1. This figure shows a transmitter 12 and a receiver 14, both with multiple antennas, defining an OFDM channel therebetween. The transmitter 12 comprises a data source 16, which provides data (comprising information bits or symbols) to a channel encoder 18. The channel encoder 18 in this example comprises a convolutional coder such as a recursive systematic convolutional (RSC) encoder. The channel encoder 18 operates such that more bits are output from the encoder than are presented to its input, and typically the rate is one half or one third.

The channel encoder presents the encoded bits to a channel interleaver 20, in the illustrated embodiment, a space-time encoder 22. The channel interleaver 20 interleaves the bits into symbols in a manner that ensures that errors do not arise due to repeated transmission of a bit in a certain position in a data frame from the same antenna, or that adjacent bits are separated so that errors due to breaks in transmission are possibly capable of being recovered.

The space-time encoder 22 encodes an incoming symbol or symbols as a plurality of code symbols for simultaneous transmission from a transmitter antenna array 24 comprising a plurality of transmit antennas 25. In this illustrated example, three transmit antennas 25 are provided. In the general case, the number of transmit antennas is designated Tₓ.

The encoded transmitted signals propagate through a MIMO channel 28 defined between the transmit antenna array 24 and a corresponding receive antenna array 26 of the receiver 16. The receive antenna array 26 comprises a plurality Rₓ of receive antennas 27 which provide a plurality of inputs to a space-time (and/or frequency) decoder 30 of the receiver 16. In this specific embodiment, the receive antenna array 26 comprises three receive antennas 27.

In the general case, it is merely a condition of operability that Rₓ≧Tₓ.

The space-time decoder 30 is operable to remove the effect of the encoder 22. The receiver 14 of the specific embodiment is configured with the transmitter 12 in mind. The output of the space-time decoder 30 comprises a plurality of signal streams, one for each transmit antenna 25, each carrying so-called soft or likelihood data on the probability of a transmitted symbol having a particular value. This data is provided to a channel de-interleaver 32 which reverses the effect of the channel interleaver 20 and outputs convolutional code on the basis of the likelihood data provided by the space-time decoder 30.

The convolutional code output by the channel de-interleaver 32 is then presented to a channel decoder 34. In this example, the channel decoder 34 is a Viterbi decoder, which is operable to decode the convolutional code.

The channel decoder 34 is a SISO (soft-in soft-out) decoder, that is operable to receive symbol (or bit) likelihood data and to provide similar likelihood data as an output rather than, say, data on which a hard decision has been made. The output of channel decoder 34 is provided to a data sink 36, for further processing of the data in any desired manner.

The channel decoder 34 further presents its output to a further channel interleaver 38, of equivalent design to the channel interleaver 20 of the transmitter 12, and thus interleaves the decoded received data in the same manner as the original data had been interleaved in the transmitter 12. This interleaved received data is then presented back to the space-time decoder 30, as a priori data for use in the space-time decoding process.

At the outset of the operation of the channel decoder 30, an initial channel estimate operation is performed. This can be done in accordance with any known technique, such as using a pre-agreed preamble for the network and per-tone estimation.

As mentioned above, smoothing of the initial frequency domain channel estimate can be achieved by filtering. Due to the correlation between the channel coefficients on different subcarriers, noise can be suppressed by applying a filter. The optimal filter, in terms of mean-squared error, is the Wiener filter which depends on the correlation between channel coefficients.

One example is provided below for computation of the filter weights, although it will be appreciated that the invention is not limited to that specific manner of computing the filter coefficients.

An example of smoothing using the nearest active subcarriers is shown in FIG. 2 where subcarriers are filtered by linearly combining 5 subcarriers. In FIG. 2, circular symbols are used to designate subcarriers, wherein filled circular symbols are present in the received signal, and unfilled circular symbols represent virtual subcarriers. As illustrated, these are at the edge of the band of subcarriers. Only a small portion of the total number of subcarriers is illustrated, for reasons of clarity.

Since the channel correlation is only dependent on the distance between two subcarriers, not the actual subcarrier locations, the filter coefficients are the same in cases (b) and (c). This is because all subcarriers in the range to be used (indicated by a rectangle bounding the subcarriers concerned) in estimating the subcarrier of interest (indicated by a square symbol) are real subcarriers received by the receiver on the channel.

However a problem would arise in case (a) which is presented in terms of conventional subcarrier estimation, in which it is proposed to use four active subcarriers illustrated to the right of the subcarrier to be estimated, plus the subcarrier in question itself. This is because the prior art filter would use the nearest active subcarriers. In case (a) it does not use the two neighbouring subcarriers on each side and the subcarrier itself for the filtering since there are no active subcarriers to the left.

This means that the filtering operation in case (a) would be forced to use subcarriers respectively three and four places away from the subcarrier of interest. In comparison to the set of subcarriers used in cases (b) and (c), this will mean that the filter coefficients for case (a) will need to be different. One implication of this is that many precomputed filter coefficients need to be stored to and fetched from memory, making a software and/or hardware implementation more complicated. It can be shown that if the filter length is 2P+1, then 2P different sets of filter coefficients are needed.

It would be desirable to always use the same (relative) filter window, as illustrated in FIG. 3. This has the advantage of always using the same filter coefficients, which simplifies storage and minimises memory access. The drawback is that in case (a) virtual subcarriers are used which provide no information about the subcarrier to be estimated. Even if the final estimate is scaled to compensate for their absence (for a flat channel, the scaling factor would be 5/3 in this example), the subcarriers near the edge of the band will be of poor quality.

Instead of this, the specific embodiment of the invention mitigate the problems of virtual subcarriers in the filter window, by firstly extrapolating the active subcarriers to the virtual ones. This can be done in many ways. In one appropriate example, a Wiener filter could be employed to make use of the channel correlation. However, in the present embodiment, the information for the virtual subcarrier(s) is simply copied from available subcarriers. An example of this is shown in FIG. 4. As shown in case (a), estimation of a subcarrier is to be attempted, even though the block of five subcarriers on which the target subcarrier is centred has at its leftmost extremity a virtual subcarrier. As a first step, therefore, information is copied from the subcarrier adjacent to this virtual subcarrier, which is the first available subcarrier with active channel information.

By this method, all filter windows will now contain information-carrying subcarriers since all virtual subcarriers have extrapolated values. This technique combines the simplicity of a fixed FIR filter with the performance benefits of using the nearest active subcarriers. Naturally, it can be used for any number of virtual subcarriers in the filter window.

In the described MIMO OFDM system, each individual channel from a transmit-receive antenna pair would be filtered according to the above description.

The processing flow of the specific embodiment is as illustrated in FIG. 5 and set out as follows:
1. Firstly (step S1-2) an initial channel estimate is obtained using, for example, a preamble and per-tone estimation.
2. Then the virtual subcarriers nearest to the band edge are replaced (step S1-4) using an extrapolation. A trivial extrapolation would be to copy the value of the nearest active subcarrier to the target virtual subcarriers. The number of virtual subcarriers to be replaced in this way is dependent on the length of the filter employed. In the examples set out above, the length is 5 and so 2 virtual subcarriers will be replaced. More generally, a filter will be of 2P+1 and the number of virtual subcarriers to be replaced will consequently be P.
3. Moreover, as part of this, if a spurious virtual subcarrier exists in the band, this is replaced with the average of its neighbours. This could arise if the DC subcarrier (which is almost never used for communication purposes) is situated in the band.
4. A loop is then commenced for all subcarriers (Step S1-6).
5. An FIR filter is then applied (step S1-8) with fixed coefficients and the relevant output is selected.
6. The loop is completed for all subcarriers (step S1-10).

In the illustrated MIMO system, the procedure will be repeated for all MIMO channels. That is, the filtering is conducted in the frequency domain of all spatial channels.

The main advantage of this specific embodiment of the invention is that a simple FIR filter with fixed coefficients can be used for frequency-domain filtering to enhance OFDM channel estimation. It has the surprising effect of achieving much the same performance as using only the nearest active subcarriers, which has the drawback of having to update the filter coefficients during the filtering procedure. The extrapolation, according to results of simulations has no marked effect on the accuracy of channel estimation and, as noted above, avoids problems associated with introducing sources of computational complexity.

As noted above, a typical filter will now be described. To estimate the channel coefficient on a subcarrier k, the nearest P subcarriers on each side is used. That is, the filter window is \tilde{h}=(\tilde{h}_{k-P} . . . \tilde{h}_{k+P}) where \tilde{h}ᵢ is the initial channel estimate, for example from a training sequence. The Wiener filter minimises the mean-squared error between the channel coefficient hₖ and its estimate \tilde{h}ₖ=w^{H}\tilde{h}, where w are the 2P+1 filter coefficients. The optimal coefficients are found as w=R_{\tilde{h}\tilde{h}}⁻¹R_{\tilde{h}h}, where R_{\tilde{h}\tilde{h}}=E{\tilde{h}\tilde{h}^{H}} is the autocorrelation of the observation and r_{\tilde{h}h}=E{\tilde{h}h^{·}} correlation between the observation and the channel coefficient to estimate. Although the actual channel correlation is rarely known, a design correlation can be chosen to fulfil certain criteria, such as robustness to mismatch between the design and actual correlation. This is noted in “OFDM channel estimation by singular value decomposition” (Edfors, O.; Sandell, M.; van de Beek, J.-J.; Wilson, S. K.; Boijesson, P. O.; IEEE Transactions on Communications Volume 46, Issue 7, July 1998 pages 931-939).

Although it will be appreciated that the foregoing is an appropriate filter to be used in these circumstances, it is emphasised that this is provided by way of example only and the application of the invention is not primarily concerned with the manner in which filter coefficients are chosen.

As noted above, it has been observed that the specific embodiment provides improved performance over existing techniques, and performance approaching a theoretically ideal, but impractical, solution.

The advantages of using extrapolated virtual subcarriers in the filter window are illustrated in FIG. 6. The simulation is based on IEEE802.11n and the parameters are: 3 transmit and 3 receive antennas (as illustrated in FIG. 1), 2 data streams, 16 QAM modulation, code rate ¾ and channel model D. The filter length parameter is P=3. That is, 2P+1=7 filter taps are used and the coefficients are from a Wiener filter with design correlation of a uniform power-delay spread with 16 samples.

Three ways of filtering to refine channel estimates are simulated:
1. ‘Nearest neighbour (varying FIR)’ which always uses the 2P+1 nearest active subcarriers;
2. ‘Fixed FIR’ which uses the nearest 2P+1 subcarriers, active or not; and
3. ‘Fixed FIR with extrapolated virtual subcarriers’ which replaces the virtual subcarriers with the nearest active subcarrier.

The first approach requires 2P different sets of coefficients (depending on which subcarrier is estimated), while approaches 2 and 3 only require one fixed set of filter coefficients. As can be seen, there is no performance degradation by using a fixed FIR filter if the virtual subcarriers are extrapolated. On the other hand, if no extrapolation takes place (approach 2), an error floor appears and the Bit error rate (BER) is severely degraded.

This demonstrates that the approach exemplified above has performance advantages compared both with the simple to implement (but inaccurate) approach 2, and the computationally complex (but highly theoretically accurate) approach 1.

As will be understood by the reader, the presently described embodiment is but one of many possible implementations of the invention and the specific description should in no way be considered as imposing a limitation on the scope of protection sought herein, which is defined in the claims appended hereto.

1. Communications apparatus for receiving a signal comprising a plurality of signal elements, the elements being modulated across a plurality of subcarriers defined by way of transmission frequency, the apparatus comprising channel estimation means operable to determine a channel estimate comprising a plurality of respective subcarrier estimates, the channel estimation means comprising a filter operable to smooth an initial estimate for a subcarrier by reference to one or more adjacent subcarrier estimates, wherein the channel estimation means further comprises extrapolation means operable to impose on a subcarrier information dependent on one or more other subcarriers in the case that the subcarrier in question is not in use other than use by said filter.

2. Apparatus in accordance with claim 1 wherein said filter is operable to smooth an initial estimate for a subcarrier by reference to one or more subcarrier estimates to one side of said subcarrier and to the same number of subcarrier estimates on the other side of said subcarrier.

3. Apparatus in accordance with claim 2 wherein said filter is operable to smooth an initial estimate for a target subcarrier by reference to said initial estimate and initial subcarrier estimates for four further subcarriers, two being directly adjacent said subcarrier and two being directly adjacent said directly adjacent subcarriers distal said target subcarrier.

4. Apparatus in accordance with claim 1 wherein said filter is a linear filter.

5. Apparatus in accordance with claim 4 wherein said filter is a linear filter defined by a plurality of filter coefficients, said filter coefficients being fixed.

6. Apparatus in accordance with claim 1 wherein the extrapolation means is operable to determine information to be imposed on a subcarrier as a copy of information of another subcarrier.

7. Apparatus in accordance with claim 1 wherein the extrapolation means is operable to extrapolate from one or more other subcarriers information to be imposed on a subcarrier.

8. Apparatus in accordance with claim 1 wherein said extrapolation means is operable on a subcarrier otherwise not in use, to impose information on said subcarrier to enable use of said subcarrier as one of said adjacent subcarriers for use by said filter.

9. Method of determining a channel estimate for a channel comprising a plurality of subcarriers by frequency, comprising the steps of determining an initial estimate for each subcarrier utilised in said channel, identifying further subcarriers adjacent said utilised subcarriers to enable use of a fixed window filter on each said utilised subcarrier, extrapolating initial subcarrier information to a further subcarrier from one or more utilised subcarriers, and filtering subcarrier information for a plurality of subcarriers using said fixed window filter to determine a smoothed estimate for each utilised subcarrier.

10. Method in accordance with claim 9 wherein said filtering step comprises smoothing an initial estimate for each utilised subcarrier by reference to one or more subcarrier estimates to one side of said utilised subcarrier and to the same number of subcarrier estimates on the other side of said utilised subcarrier.

11. Method in accordance with claim 10 wherein said filtering step comprises smoothing an initial estimate for each utilised subcarrier by reference to said initial estimate and initial subcarrier estimates for four further subcarriers, two being directly adjacent said utilised subcarrier and two being directly adjacent said directly adjacent subcarriers distal said utilised subcarrier.

12. Method in accordance with claim 9 wherein said filtering step comprises applying a linear filter to the utilised subcarrier and said further subcarriers to determine a filtered estimate for said utilised subcarrier.

13. Method in accordance with claim 9 wherein said filtering step comprises linearly combining said subcarrier information.

14. Method in accordance with claim 13 wherein said step of linearly combining is configured by a plurality of filter coefficients, said filter coefficients being fixed.

15. Method in accordance with claim 9 wherein said extrapolation step comprises determining information to be imposed on an identified further subcarrier as a copy of information of another, utilised, subcarrier.

16. Method in accordance with claim 9 wherein said extrapolation step comprises determining information to be imposed on an identified further subcarrier comprises extrapolating from one or more other subcarriers information to be imposed on a subcarrier.

17. Method in accordance with claim 9 wherein said extrapolation step operates on a subcarrier otherwise not in use, to impose information on said subcarrier to enable use of said subcarrier as one of said adjacent subcarriers for use by said filter.

18. Computer program product storing computer executable instructions operable to cause a general purpose computer communications apparatus to become configured as apparatus in accordance with claim 1 or to perform a method in accordance with claim 9.

19. Communications network comprising at least one communications apparatus in accordance with any one of claims 1 to 8.
